(19) United States
(12) Patent Application Publication
(10) Pub. No.: US 2008/0288350 A1
(43) Pub. Date: Nov. 20, 2008

(54) SYSTEM AND METHOD FOR ENABLING ADVERTISERS TO PURCHASE ADVERTISEMENT SPACE IN VIDEO GAMES

(75) Inventors: Jeffrey A. Iris, West Simsbury, CT (US); Andrew S. Kimball, Glastonbury, CT (US); Jacob Oster, Lancaster, PA (US)

Correspondence Address: MCCORMICK, PAULDING & HUBER LLP, CITY PLACE II, 185 ASYLUM STREET, HARTFORD, CT, 06103, US

(73) Assignee: QwikPlay LLC, Simsbury, CT (US)

(21) Appl. No.: 12/122,225

(22) Filed: May 16, 2008

Related U.S. Application Data
(60) Provisional application No. 60/938,828, filed on May 18, 2007.

(51) Int. Cl. G06Q 30/00

(52) U.S. Cl. 705/14

(57) ABSTRACT

The present invention provides a method for advertisers to send messages to targeted audiences in a video game. The messages are multimedia in nature (images and movies) and displayed in non-game play areas of games so that it does not interfere with the game play experience of the game player. The game playing audience is targeted based on the game itself and the type of game. The advertiser selects the demographic information of the gamers (collectively consumers of games, or game players) they want to reach and when the game requests ads from the server, the server matches the game and game type to the advertiser's request.

### CROSS REFERENCE TO RELATED APPLICATIONS

This application claims the benefit of and hereby incorporates by reference in its entirety Provisional application Ser. No. 60/938,828, filed on May 18, 2007.

### FIELD OF THE INVENTION

This invention relates to an internet-based system for automated connection among advertisers, video game companies, and video game players. In particular, the present invention relates to the automated process of directing advertisements to targeted video game players and for compensating game companies based on the number of advertisements viewed by video game players.

### BACKGROUND OF THE INVENTION

Advertisers are finding it difficult to reach their target audiences as newer forms of media are replacing traditional forms of media. Usage of internet and video games by a broader group of users continues to rise, while usage of television and print media is declining. The type of person playing video games today has changed to include people of all backgrounds and interests. Video games, therefore, provide a very desirable media for advertisers to reach their desired audiences. Some existing advertising in video games is considered product placement where the advertisements are placed in the background of the game play. This type of advertising in video games is very challenging to properly execute and have the game player left with a positive brand impression. If the advertisement is too subtle, the game player never notices the ad and if it is too blatant, the suspension of disbelief is lost and the game player has a negative perception of the brand. Placing a non-distractive and yet effective advertisement in a video game remains challenging to Advertisers.

Advertisers aside, video game companies, traditionally, have only made money when a player has purchased a game they have either developed or published. With the wider adoption of high speed internet access, advertising-based business model has emerged for video game companies. Although this model seems promising, the integration of ad serving technology into a video game has been a time consuming and challenging process. A top tier video game can take years to create and integration requires a large investment of time and effort to complete. Reducing the investment to integrate ad serving technology and enabling older or existing games to use the ad serving technology means that a video game company can see a high return on investment in the process as a whole.

### SUMMARY OF THE INVENTION

The present invention provides a method for advertisers to send messages to targeted audiences in a video game. The messages are multimedia in nature (images and movies) and displayed in non-game play areas of games so that it does not interfere with the game play experience of the game player. The game playing audience is targeted based on the game itself and the type of game. The advertiser selects the demographic information of the gamers (collectively consumers of games, or game players) they want to reach and when the game requests ads from the server, the server matches the game and game type to the advertiser's request.

The advertisers purchase the ad space and the game companies are compensated based on the verified viewed advertisements. The advertisers and game companies can view the results of the advertisement views using the reporting features of the server which is a part of the present invention. The advertisers can easily see how a campaign is performing and then drill further into the details of the campaign to see how each ad is performing. The advertiser can change the advertisements to be as effective as possible, even while an advertising campaign is still in progress. The game company can also view reports of the results of the ad views. The game company reports focus permit a greater focus on the technology between the games and the players. For example, the reports include, but are not limited to, the method of rendering, screen resolution settings of the users, and operating systems.

The system allows the advertisements to be downloaded from the service server from where they are played regardless of the distribution model. A game can be distributed on physical media or via the Internet which enables the game company to use the model that best suits their business and the advertiser to know that the advertisements are reaching the audience wherever the game is played.

### BRIEF DESCRIPTION OF THE DRAWINGS

FIG. 1 is a schematic block diagram illustrating an automated advertisement-video game broker system in accordance with an embodiment of the present invention.

FIG. 2 is a schematic illustration of how an advertiser interacts with the broker service.

FIG. 3 is a schematic illustration of how a game company interacts with the broker service.

FIG. 4 illustrates how a game company integrates the service enabling Software Development Kit (SDK) into a video game.

FIG. 5 illustrates a web interface provided by the broker service for an advertiser to create a new advertising campaign.

FIG. 6 illustrates a web interface provided by the broker service for an advertiser to edit an existing advertising campaign.

FIG. 7 illustrates a web interface provided by broker service for a game company to register a new video game with broker service.

FIG. 8 illustrates a web page showing the game information of a registered video game.

FIG. 9 is a schematic illustration of how a game player interacts with the broker service.

FIG. 10 illustrated how a registered video game is loaded concurrently with the loading advertisement contents and information from broker service.

FIG. 11 is a showing of how the computer program inside the broker server serves advertisements to video game while the game is played.

FIG. 12 shows the elements of a bitmap of the description of an advertisement, on which the broker's service find the best matched advertisement.

FIG. 13 shows one way to retrieve advertisements—directly from datastore located on the computer.

FIG. 14 shows another way to retrieve advertisements—from system input and output, and then store them back to datastore located on the computer.

FIG. 15 shows how a video game, while is played, retrieves advertisements: first look for them locally, display them if they are local; if not, ask for them from broker's service; and then store them locally.

FIG. 16 illustrates that both advertisers and game companies can view data reports generated by broker's service.

FIG. 17 shows a few sample data reports generated by broker's service.

FIG. 18 illustrates how broker service verifies a displayed advertisement by comparing the fingerprints of the advertisement with the advertisement's meta data.

FIG. 19 illustrates the steps how broker's service conduct the verification.

FIG. 20 illustrates the yes-no decision when a registered video game gets an advertisement.

FIG. 21 is a flow chart showing the steps of getting a flash advertisement.

FIG. 22 is a flow chart showing the steps of getting a non-flash advertisement.

FIG. 23 is a flow chart showing the steps of displaying an advertisement.

FIG. 24 is a flow chart showing the steps of creating fingerprint points for a displayed advertisement.

FIG. 25 is a flow chart showing some steps of validating fingerprint points for a displayed advertisement.

FIG. 26 is a flow chart, as a continuation of FIG. 25, showing the rest steps of validating fingerprint points for a displayed advertisement.

FIG. 27 is a diagram showing a database schema of advertisement campaign.

FIG. 28 is the “Campaign” table filled with some exemplary data.

FIG. 29 is the “CampaignState” table filled with some exemplary data.

FIG. 30 is the “AudienceSettingGameType” table filled with some exemplary data.

FIG. 31 is the “GameTypes” table filled with some exemplary data.

FIG. 32 is the “AudienceSettingGeographicType” table filled with some exemplary data.

FIG. 33 is the “AudienceSettingGeographicSelection” table filled with some exemplary data.

FIG. 34 is the “Ad” table filled with some exemplary data.

FIG. 35 is the “AdContent” table filled with some exemplary data.

FIG. 36 is the “AdContentStates” table filled with some exemplary data.

FIG. 37 is the “Game” table filled with some exemplary data.

FIG. 38 is the “GameStates” table filled with some exemplary data.

FIG. 39 is the “AdViews” table filled with some exemplary data.

### DETAILED DESCRIPTION OF PREFERRED EMBODIMENT

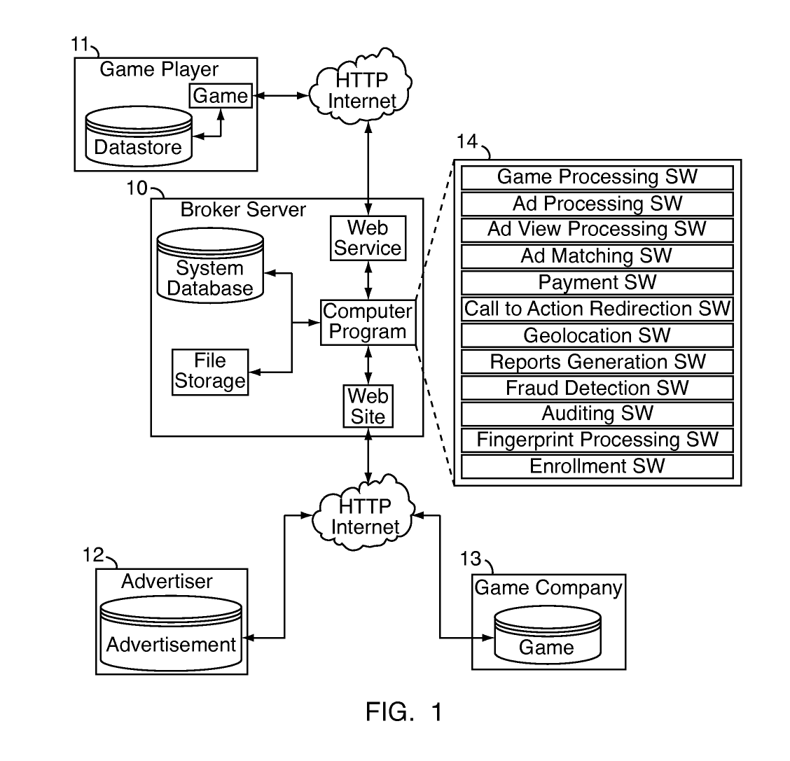

FIG. 1 shows an internet-based system 1 acting as a broker between an advertiser 12 and a video game company 13, providing video game company with broker service 10 which gives the advertiser an easy way to purchase advertisement space in a video game manufactured by the video game company, and enables the advertiser effectively reach targeted video game players 11, and at the same time, provides the video game company an easy way to offer available advertisement space for advertisers, and compensates the video game company based on the number of advertisements been viewed by video game players. The advertisement broker system, as discussed further below, on the one hand, allows advertisers, via advertisement campaigns, to register their advertisements along with information about the targeted audiences; on the other hand, allows video game companies register video games along with game information. The registered games and registered advertisements are matched and the selected advertisements will be displayed, in a non-interrupted way, during game time to reach targeted game players.

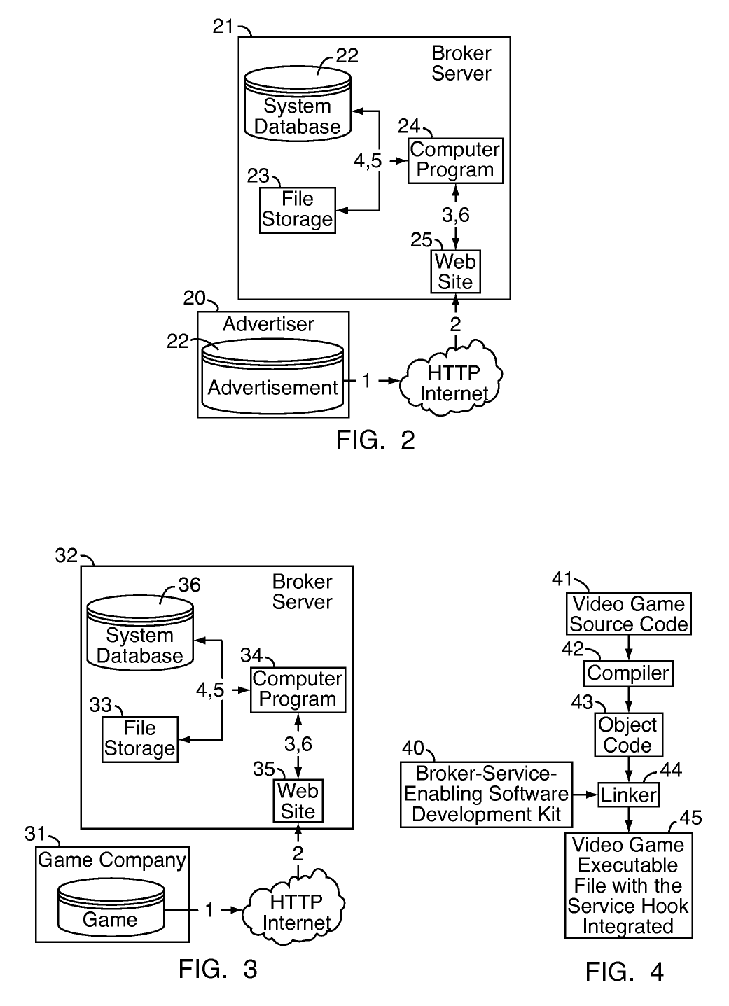

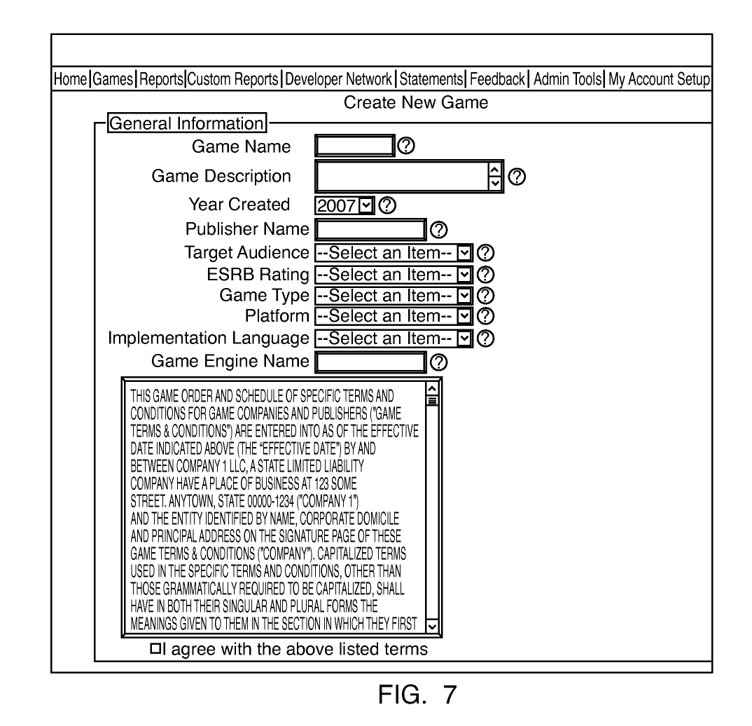

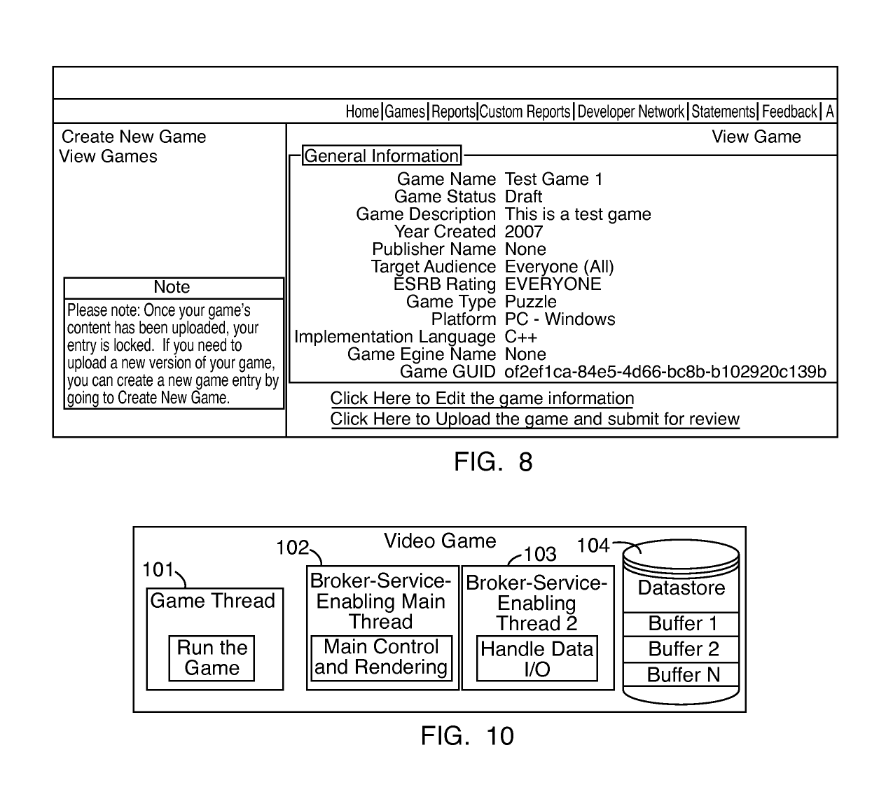

The advertisement (a.k.a. Ad) broker system delivers advertisements dynamically into non-gameplay areas (a time period during which no video game is shown on the screen) of web based and PC based video games. The service allows advertisers to connect and interact with their target audiences (FIG. 2), and provides a way for the video game companies to realize new revenue streams while retaining control over their product (FIG. 3). The broker's website allows advertisers or video game companies to register for the service (FIG. 7 and FIG. 8).

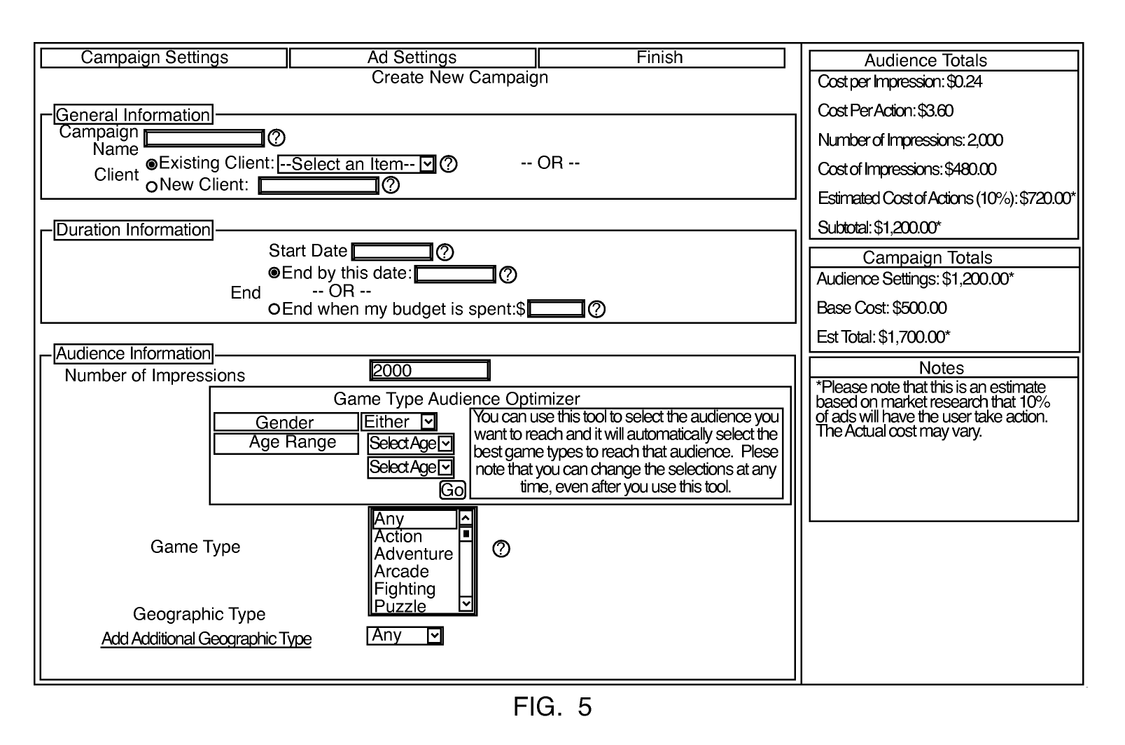

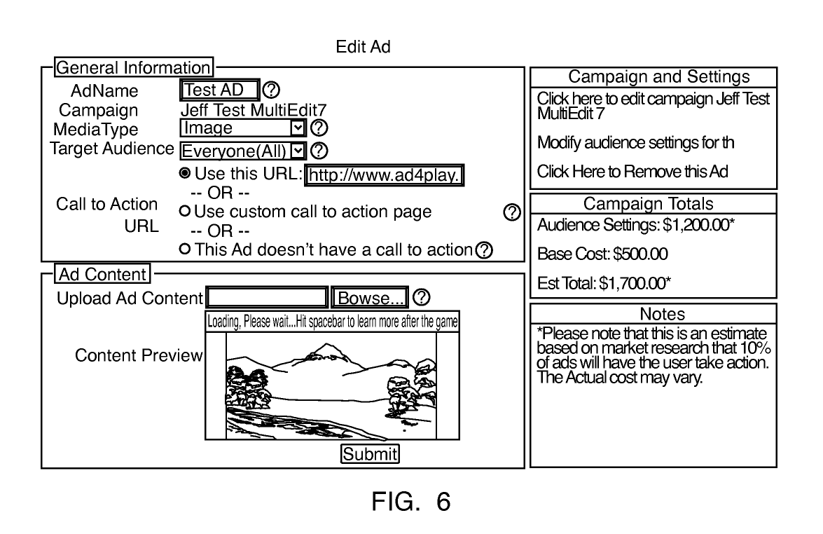

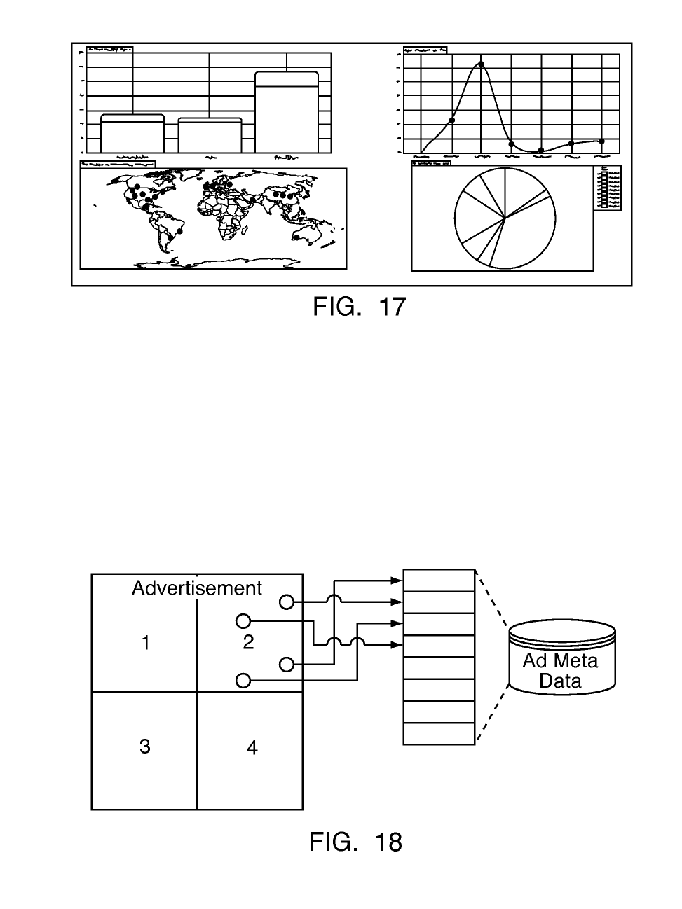

Once registered with the broker's website the advertiser sets up a campaign (a logical grouping of advertisements that together constitute a marketing effort) by defining the trafficking criteria and uploads the new or existing advertising content to the broker's website (FIG. 5). The advertiser has the ability to modify the campaign settings or content at any time (FIG. 6). Once satisfied with the settings and content, the advertiser submits the campaign for activation and distribution to video games using the broker's webservice. Once registered with the broker's website the video game company downloads the software development kit and integrates it with the video game company's game (FIG. 4). The integration process involves modifying the video game source code 41, compiling the source code 42 into object code 43, and link 44 with the library provided by the broker-service-enabling SDK 40, generating an executable file 45. The video game company tests the enabled game and uses the broker's websites real time reports (FIG. 17) to verify the results. The video game company submits the enabled game in its final release form to the broker's website for review and activation. Once activated, the enabled game receives dynamic advertisements.

If the dynamic advertisement is a Paid Verified Ad View (a Paid Verified Ad View occurs when: (a) a Creative (advertising creative and any related content provided by third party advertising agencies to promote a brand, product and/or service on behalf of their clients, including, through buttons, banners, text-links, pop-ups, and pop-unders) is downloaded from the broker's server and placed in an Authorized Game (a game that has been approved by advertisement-video game broker system and that has been assigned a game-unique identifier); (b) the Creative is displayed in the Authorized Game; (c) the display information is subsequently transmitted back to the broker's server without error; and (d) the applicable advertiser pays broker company for such Creative placement), then the video game company receives payment for the number of Paid Verified Ad Views (Creatives that are uploaded by the advertiser to broker's server, downloaded from the broker's server and displayed in a game developer's game, and for which Creative view information is transmitted to the broker's server) that occurred in all Authorized Games from the video game company. The advertiser tracks the progress of the campaigns using the broker's website real time reports feature (FIG. 16 and FIG. 17). Every pre-defined time period (e.g. 30 days), the advertiser is invoiced for the impressions and actions taken for all of the advertisers campaigns in the last fixed period.

The broker's service is a software package with several key components (FIG. 1, 14). The first component is a web site that grants access to advertisers and video game companies for downloading needed software, submitting advertisements and video games, viewing results of ad views, as well as other standard web site features (such as user administration, password recovery, etc). Another component is the web service that handles the advertisement distribution and ad view data transmissions to and from the game players. Both the web site and web server rely on another component known as the computer program. The website and webservice use the computer program to handle major activities including but not limited to Game processing, ad processing, ad view processing, ad matching, payments, call to action redirection, geo-location, report generation, enrollment, user management, fraud detection, game type data, audience statistical data, and auditing. Another component of the system is the system database. The system database stores all data for the system and is the central repository for most data. See FIGS. 27˜39 for a list of some of the data stored. The other area used for data storage is the file system of the broker's server. Advertisements and games are stored in this area for fast access by the web service when retrieving advertisements for a game player. The website places the data in the file system and the computer program performs various actions on the files such as image processing (ad processing).

### Advertisement Campaign

The advertiser creates a campaign which is used as a logical grouping of advertisements (FIG. 2). The advertiser uses the web site to create the campaign and enter the basic information (name, brand information), duration information (start date, end date, budget amount (the campaign will be stopped once this amount is spent), audience settings (game type (the advertiser can use the Game Type Audience Optimizer tool to suggest the audience the advertiser wants), and geographic information (country, region, state, county) (see FIG. 5). Next the advertiser adds an advertisement to the campaign and must include some general information (ad name, media type, target audience, Call to Action URL—the URL configured by the advertiser that the Gamer is redirected to when the action is taken) and the ad content (see FIG. 6 and FIG. 2 step 1 and 2). The ad content is uploaded to the broker's web site where the computer program processes the images and movies into different formats so the advertisements work on different platforms the game players are using (see FIG. 2 steps 3, 4, 5, and 6). If the advertisement is a movie, the advertisement is converted to an SWF format and to an MPEG format. If the advertisement is an image, broker converts the advertisement to a JPEG and adds a border around the entire image (on all sides) broker creates the fingerprint points for this ad at this time as well.

Then once the advertiser is satisfied with all of the settings and content, the advertiser sets the campaign to ready. At this time, an email is sent to the advertiser describing the process again and an email alert is sent to the broker support email address to approve the content. Once the broker support team has reviewed the content for the advertisements and is ready to approve, the broker support team clicks on the approve button on the web site that only system administrators can see or use. This then makes these advertisements available to the live games. The campaign and advertisements can be changed after the campaign is live and in the active state using the edit campaign (modifying a campaign setting(s) after it has been created) and ad functions on the web site.

### A Game Company Registers a Video Game

The game company creates a game entry in the system as a placeholder that defines the game the game company is adding (FIG. 3). At this time, the game company must agree with the terms of service agreement and once the data has been saved, the game company receives a Game GUID. This is a unique identifier used to track the game through the process. The game company must get the service-enabling SDK from the broker's website by downloading the zip file as it contains all the needed files and help documentation. The game integration consists of copying the library and header files, setup the development environment (settings for this type of game), copy the code from help documents to the game, and replace areas that ask for the game GUID with their game GUID (FIG. 4).

The game company or publisher will test the integration into the game by running the game and verify the advertisements display as expected. The advertisements shown in the test period are sample advertisements and not Paid Verified Ad Views. The game company will confirm the tests by viewing the test reports section of the web site. Once happy with the number of ads and how it is working, the game company submits the game for approval (FIG. 7). This is done by uploading the game in its final release format via the web site for review and approval by broker service staff (see FIG. 3 steps 1,2,3 and FIG. 8). The game meta information is sent to the database from the computer program that manages the games (see FIG. 4 number 4). The game itself is saved to the file system of broker's server by the computer program that manages the games (see FIG. 3 step 5). The approval consists of verifying the content of the game, the quality of the game, fraud testing, and the advertisement placement verification. Once approval of the game has happened, the game becomes part of the live network and ads will be served to it. An email notification sent to the game company to make sure the game company is aware that the game is now live. The game company then distributes the game where and how the game company wants. This could be via the web using one or many sites or it could be on some kind of other media such as a CD or DVD for example.

### A Game Player Plays an Authorized Game

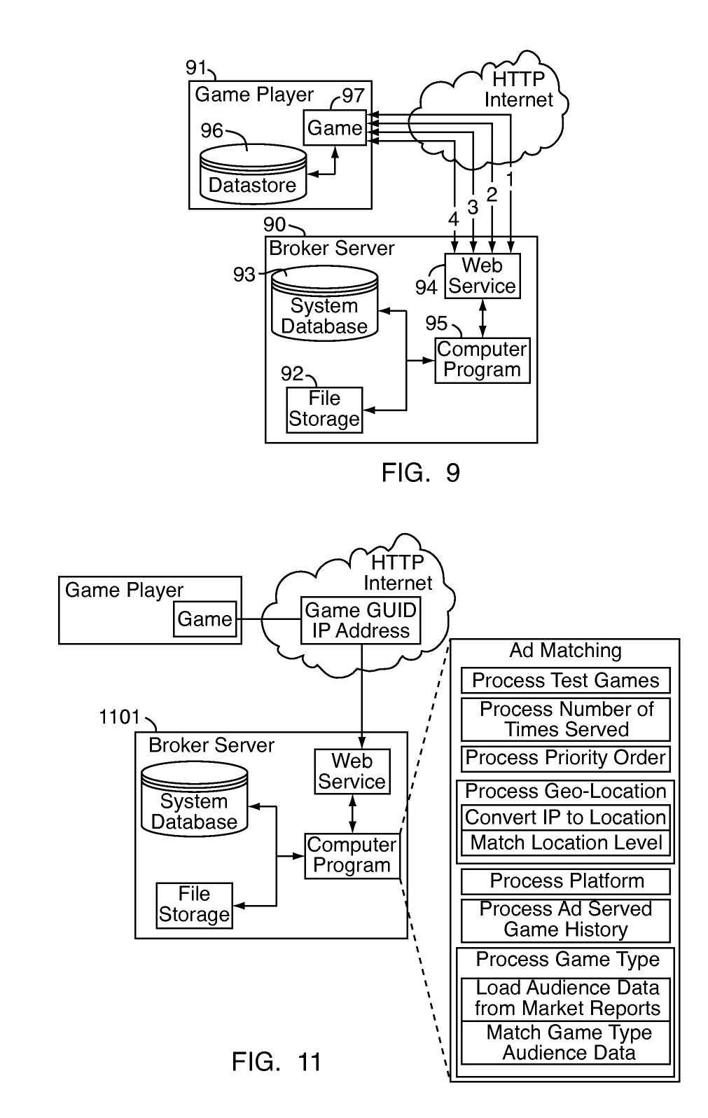

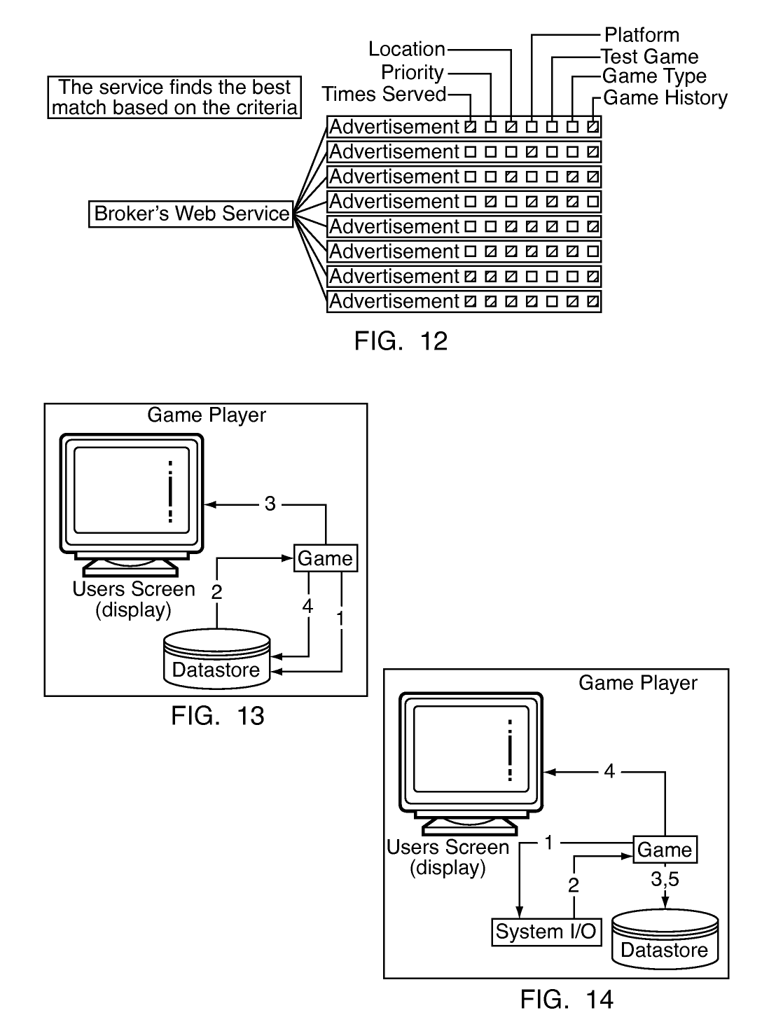

The Authorized Game being played by the Game Player receives the data from the broker's webservice using 2 steps: 1) to get the ad meta data and 2) to get the ad raw data (see FIG. 9). The meta data is data about the advertisement and includes control information such as how long the ad should be viewed, the ad GUID (a unique identifier for this advertisement), and the date and time the URL to be called if the user decides to take action. The raw data is the binary data for the advertisement which can be an image or movie. In the first step (see FIG. 9 step 1), the game GUID is sent to the broker's webservice to let the service know what game this request is coming from. During this process, the web service obtains the IP address of the game requesting a new advertisement which it then converts into a geographic location using the computer program for geo-location. Now the web service will find the advertisement to return. Based on the game GUID, geo-location, priority, number of times served, and the game type the ad to return is found and its meta data is returned (see FIG. 9 step 2). Once the game has verified the data is valid, it will request the raw ad data using the information in the meta data to build the URL to call (see FIG. 10 step 3). When the raw data is returned, the game verifies the data and sends it to the local data store (see FIG. 9 step 4). All communications between the client and server are encrypted using 128 bit AES encryption. The data store is used for games on devices with hard disk storage and is saved to the hard disk of the device but buffers are used for web based games using devices without a hard drive and are only used in memory. The data store has a flexible buffer that can have the amount of ads stored locally change. The system will get configuration updates from the server to determine how large it should be. This is based on the game information; so if a game has a long load time, broker configures different sized buffers. The buffer store the data in the data store in an encrypted format using 128 bit AES encryption and is a different encryption password then the one used for the communication. The PC based game downloads a dynamic default ad to be shown when no new ads are available and this buffer can also be varying in size. All of the downloading occurs in a separate thread (FIG. 10, broker-service-enabling thread 2, 103) which allows the game to run with minimal impact to performance from the ad downloads and processing (see FIG. 10). If there are no ads a default (non paid) ad is shown and if no ad is downloaded a default “Your Ad Here” ad is shown. The configuration updates from the server happen periodically and control the size of the ad buffers, the configuration update schedule, and the webservice URL to use.

The broker's webservice is the service provider used to serve the ad data to all platforms that have game players and handles both parts of the process for serving the ads. The web service uses the computer program to handle many of the aspects of the matching process (see FIG. 11). Every time an ad is requested and served, the details are logged to the system database by the computer program. Like mentioned before, the Game Guid is passed to the service to determine which game is requesting an Ad. The IP address is passed to the computer program Geo-Location software where it is converted to a geo-location. The matching process works on the list of all data (list of all advertisements; the audience data for Game Types, Geographic Selection, Geographic Types (country, region, state, county, zip code); cost settings, duration settings, esrb ratings (the Entertainment Software Rating Board (ESRB) rating system provides guidelines on game content to aid consumers in determining a game's content and suitability), target audience, and age range; the number of times previously served; the game ad history; and priority) by making multiple passes on the list by many components of the computer program. Each component of the computer program rates each piece of data either as a positive or negative value or weight. So for the process to complete, each component needs to scan the advertisements. This is a multipass algorithm that orders the results at the end and returns the best result. For speed, the values are placed in an Ad Queue that keeps an index of the key columns for fast retrieval. The test game component runs and determines if the game is a test game. The game type is used to filter the list of potential ads to return. The game type information is matched with the ad and campaign data. Previous loading times for the game are used to filter the length of ad to return. The location of the request is determined from the IP address of the requesting client. The location is then used to filter for the ad to return based on the country, region, state, and county. The geographic settings are stored in the campaign and ad settings and there are multiple searches used to find the best match based on the type and then the selections. A priority is assigned to each ad and is used to sort the list of ads and determine which to return. The number of times served also is used to sort the list of ads and determine which to return. When these components have completed processing, the data list is sorted and the top item is returned which points to an ad using an Ad identifier. The Ad identifier is then used to load the ad meta data and return it to the client.

### A Game Player View and Interact with Displayed Advertisement

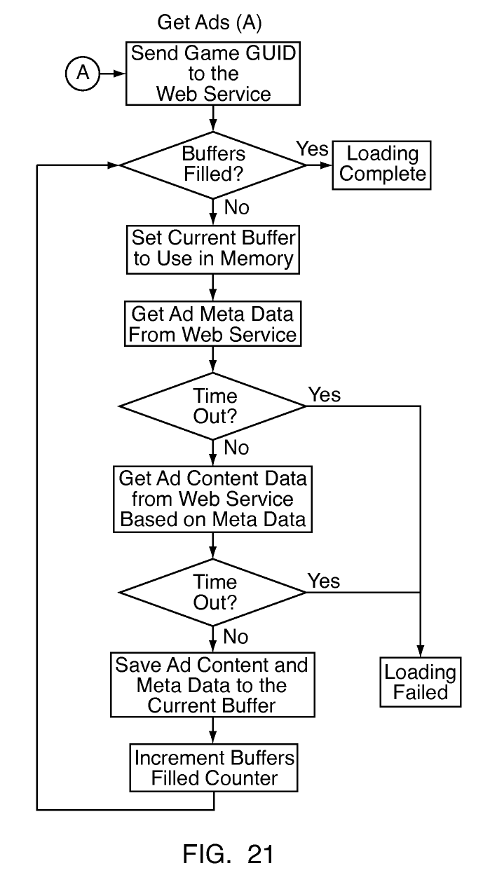

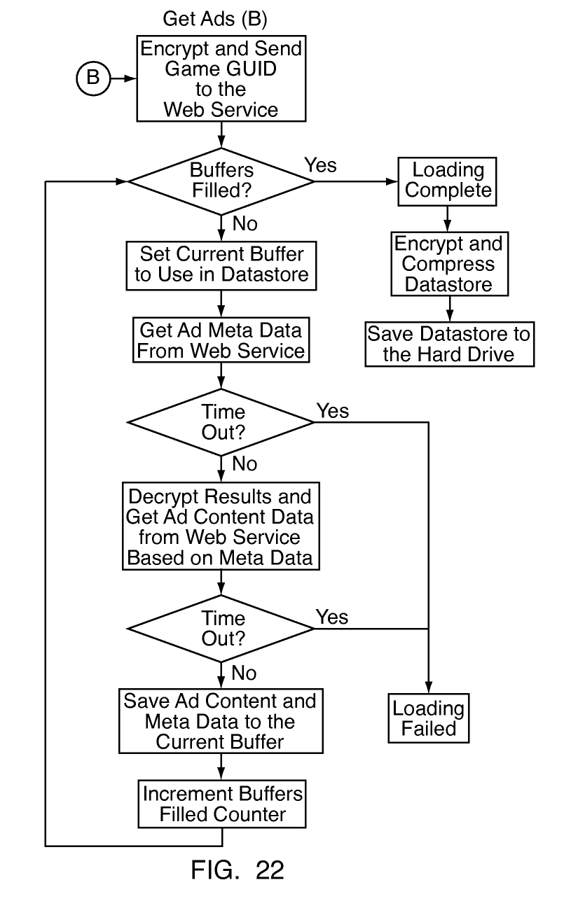

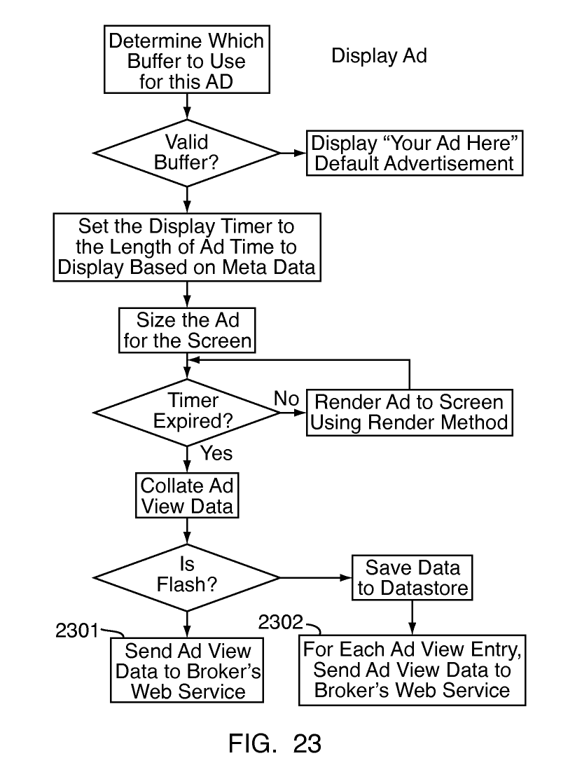

The game player views the advertisements downloaded from broker during non-game-play areas of the game. For games on devices with hard disk storage the datastore is used and is saved to the hard disk of the device but buffers are used for web based games using devices without a hard drive and are only used in memory. The datastore has buffers as well so that term will be used in this section so we can discuss the process that works regardless of hard disk capabilities. When the game triggers the code to display an advertisement, the broker-service-enabling code which has been integrated into the game (called the system) determines the ad to get from the buffer (see FIG. 13 step 1). Also, when the game needs to get an advertisement, it retrieves the advertisement based up whether or not the game is a Flash game (FIG. 20)—if the game is a Flash game, the game gets the advertisements according to the steps enumerated in FIG. 21, otherwise, the game gets the advertisements according to the steps listed in FIG. 22. With that advertisement selected, the system determines which display platform to use (OpenGL, DirectX, Flash) and based on the platform to use, it will call the appropriate methods for that type (see FIG. 13 step 2). The system will load the ad data (both the raw and meta) from the data store on the hard drive (if necessary) into memory. The meta data is used to control how long to display the ad and manage the overall process. The raw data is then formatted to the platform and rendered to the video memory where it is then displayed on the screen. The formatting includes centering the ad and sizing the ad to fit the screen. The raw data is draw to the screen at whatever rate the video game is rendering at since it is called for every frame render. The meta data then triggers the fingerprint verification function at a time created for this ad. The trigger is handled by custom windows events and separate thread (FIG. 10, broker-service-enabling main thread, 103) for the rendering and the control. Once the ad view time period has expired, the ad data is converted to the ad view data and saved to the data store (see FIG. 13 step 4). Then the system determines if it should display another ad and if so, the process repeats. FIG. 23 summarized detailed steps for displaying an advertisement.

In the case where the game player wants to learn more about an advertisement, the call to action feature is used (see FIG. 14). When the game player clicks ad, it triggers the call to action. The broker-service-enabling code which has been integrated into the game (called the system) creates an event listener (or hook) that connects with the operating system Input/Output (I/O) functions (see FIG. 14 step 1). Any input from the keyboard is received by the system and is inspected to determine if it matches the keyboard (see FIG. 14 step 2). After inspection, the system passes the message it received along the message pipeline so that any other listener (outside the system) will be triggered properly. If a match is found, the time of the action is captured and the datastore or buffer is updated along with a change to the ad view meta data (see FIG. 14 step 3). Clicking the ad trigger creates a new browser instance of the default browser for this game player that calls a URL (see FIG. 14 step 4). The URL is always pointing to the broker's web site and passes in the Ad GUID. Based on the Ad GUID, the broker's computer program Call-To-Action-Redirection component redirects the browser to the URL for the given advertisement as input by the advertiser. Broker can optionally insert a pause before the redirect happens or insert HTML and/or JavaScript to insert functionality into the final URL (such as a survey). For web based games, the URL is spawned immediately but for PC based games, the URL is spawned at the end of the game (when the game exits). If there is a problem with spawning the browser, the action is stored in the data store where it can be tried again the next time the game ends (see FIG. 14 step 5).

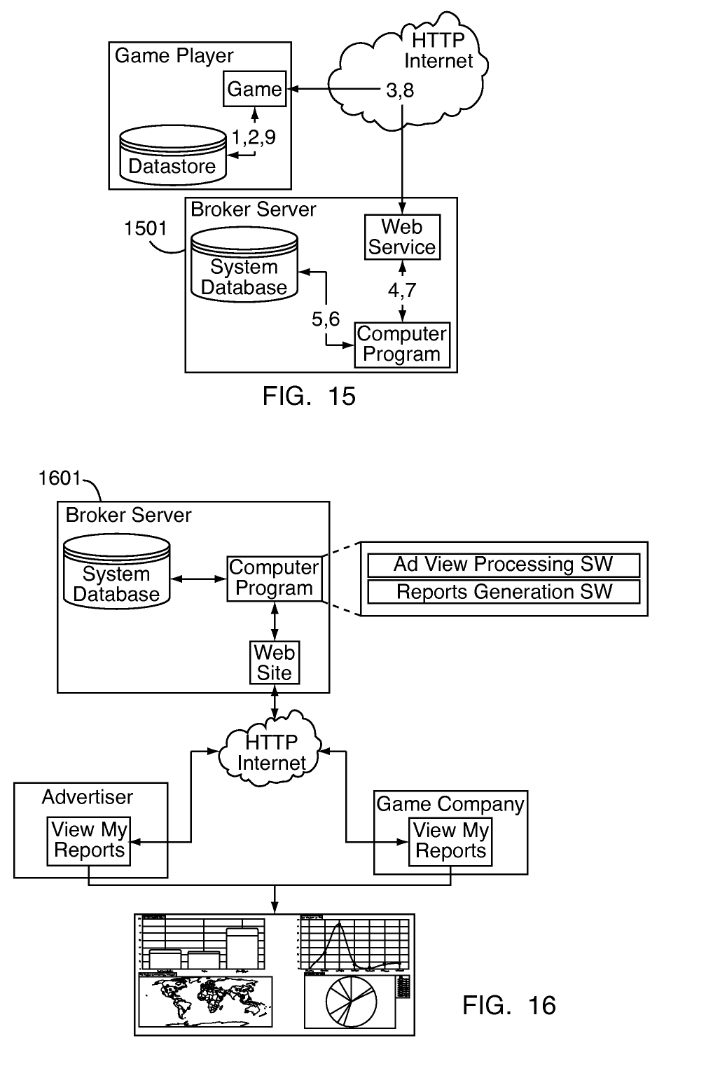

Once an ad view has been completed, the broker-service-enabling code which has been integrated into the game (called the system) sends the data back to the broker's server (see FIG. 15). For web based games the ad view information is sent to the broker's webservice immediately after the ad view has completed. For PC based games, the ad view information is stored in the local data store where the system reads all ad views in the data store and submits the data to the broker's server. The system will read the data from the datastore and the meta data is merged with other tracking data into an ad view tracking packet (see FIG. 15 steps 1 and 2). The ad view packet is sent to the broker's webservice (see FIG. 15 step 3) and the data is passed to the Ad View Processing component which logs any raw data coming into the system database to track any views that might not be processed but were submitted. The location of the request is determined from the IP address of the requesting client (using the Geo-Location component) and the Ad GUID and the Game GUID are checked to make sure that they are valid GUIDs. The Ad View data is saved to the system database and the tables used to track the information for reporting purposes are updated (see FIG. 15 steps 4 and 5). If the information is saved successfully, the computer program returns the result to the web service which then returns the result to the game player computer (see FIG. 15 steps 6, 7, and 8). If the transmission is successful, the data is removed from the local data store (see FIG. 15 step 9). If the transmission is unsuccessful (by a timeout or error code returned from the broker's server), the data remains in the local data store.

### Advertisers Track the Performance of Advertisement Placement

The advertisers need to track the progress of the campaigns that are active or have completed (see FIG. 16 and FIG. 17). The advertisers use the broker's websites real time reports to view data about the advertisers campaigns and can view the data on a company level, campaign level, and at an advertisement level. The advertisers can see the number of ad views with a breakdown of actions and impressions, over time, across geographies, and by different game types. The advertisers are allowed to download the data that makes up the reports and view the data in HTML or Microsoft Excel. The advertisers can use the drill down and link to features of the live reports to view the data from a top down approach. Each report is created by the computer program Reports Generation component as a JPG image dynamically. The advertisers are only able to see reports for campaigns that have been created by users in the broker's system that are members of the same company.

### Game Companies Track the Data how the Game been Played

The game companies also view data about Authorized Games and games that are not yet approved using the broker's websites real time reports. The game companies see real time data at many different levels including a company level and a game level. The game company views all report data for games in the test state (not yet approved) at any time as well. For each game or by company, the game company views the number of ad views by a breakdown of display type (OpenGL, DirectX, Flash), over time, across geographies, and screen resolutions. All data from the reports is available to be downloaded and viewed in HTML or in Microsoft Excel. Additionally, the game company can add custom data (called MetaData) to the ad view information to get more data about the ad view or client that the game company wants. The game company can have a custom report to view the MetaData. The field is simply a storage area for data that the game already has; for example it wont capture the video card information but if the game has code to do so, it can store the results and include that data with the ad tracking data. A good example of some data the game company might be interested in is the level of the game where the advertisement was shown.

### Broker Verifies the Viewed Advertisements

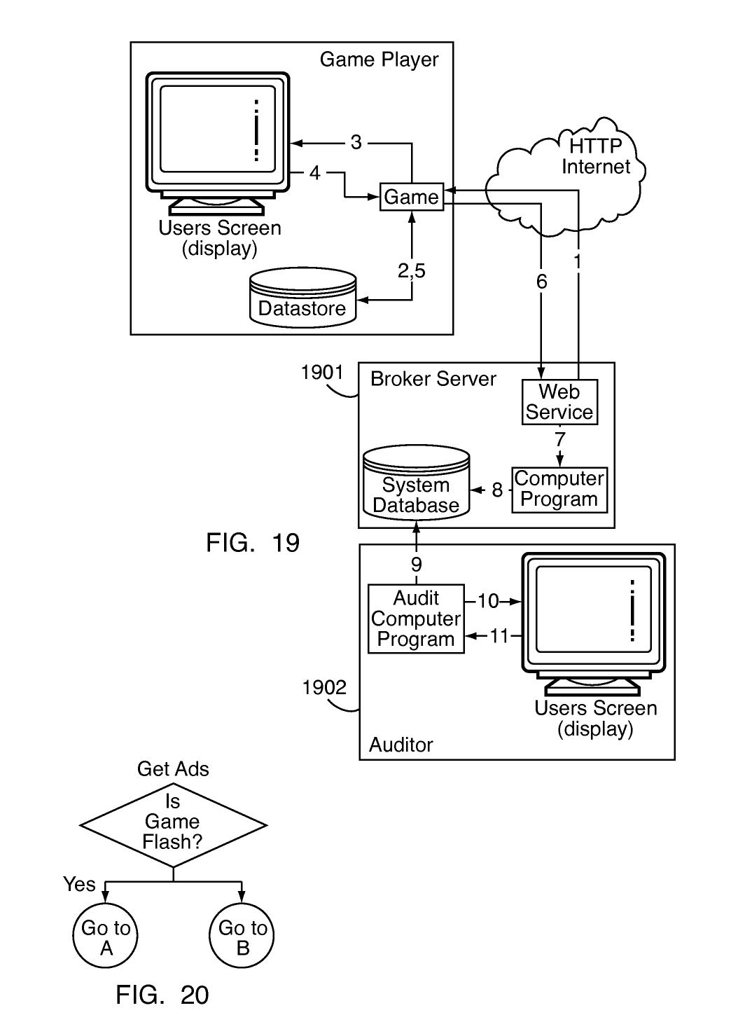

The ad views are verified from the client using the verification technology (called Fingerprints) underlining the present invention. Each advertisement has its own array of fingerprint points (x and y coordinates) that are generated when the ad is uploaded to the broker's webservice (see FIG. 18). An array stores the points to get the pixel information from and the points are created using a random number generating algorithm. The process divides the screen into 4 quadrants and uses those quadrants to ensure that pixels from the entire advertisement are used. The random numbers are generated to create x and y pairs within a given upper and lower boundary (determined by the quadrants). This array of points is then considered part of the ad meta data and is included in the data that is sent to the game requesting an advertisement (see FIG. 19 step 1 and 2).

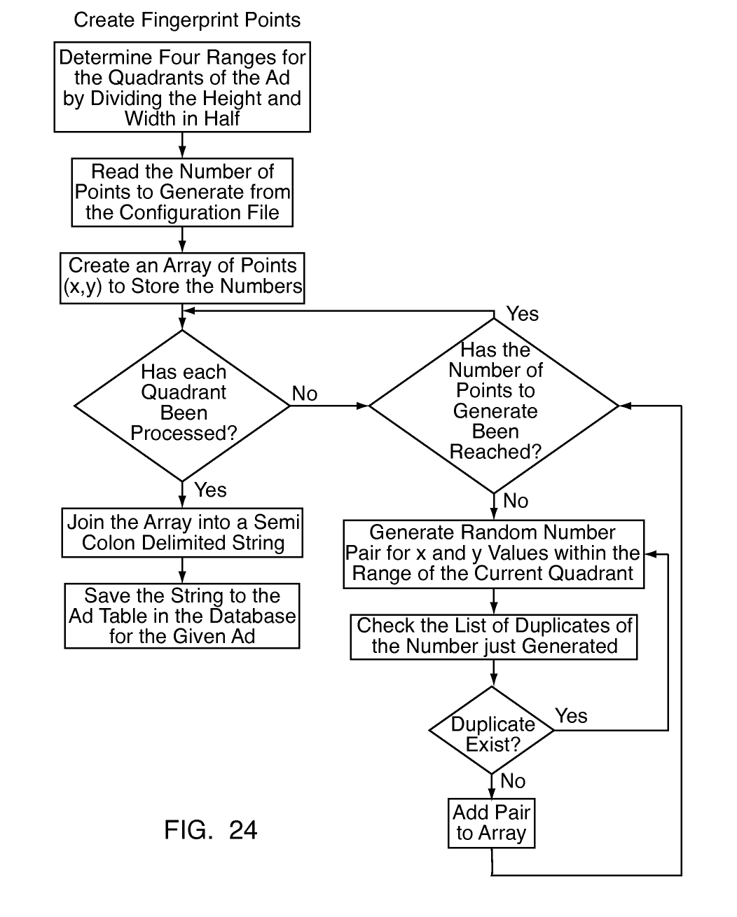

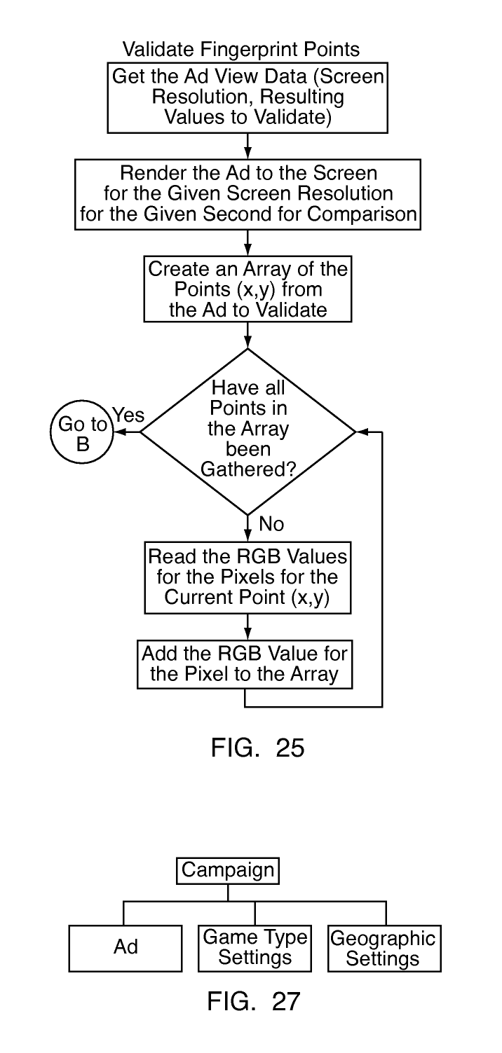

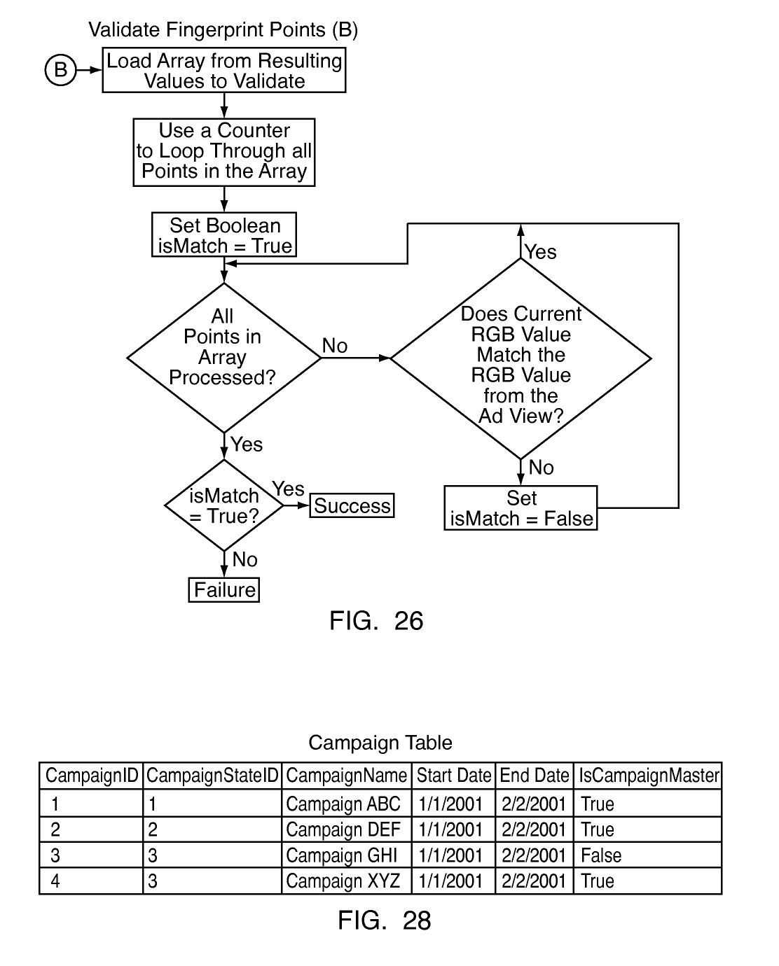

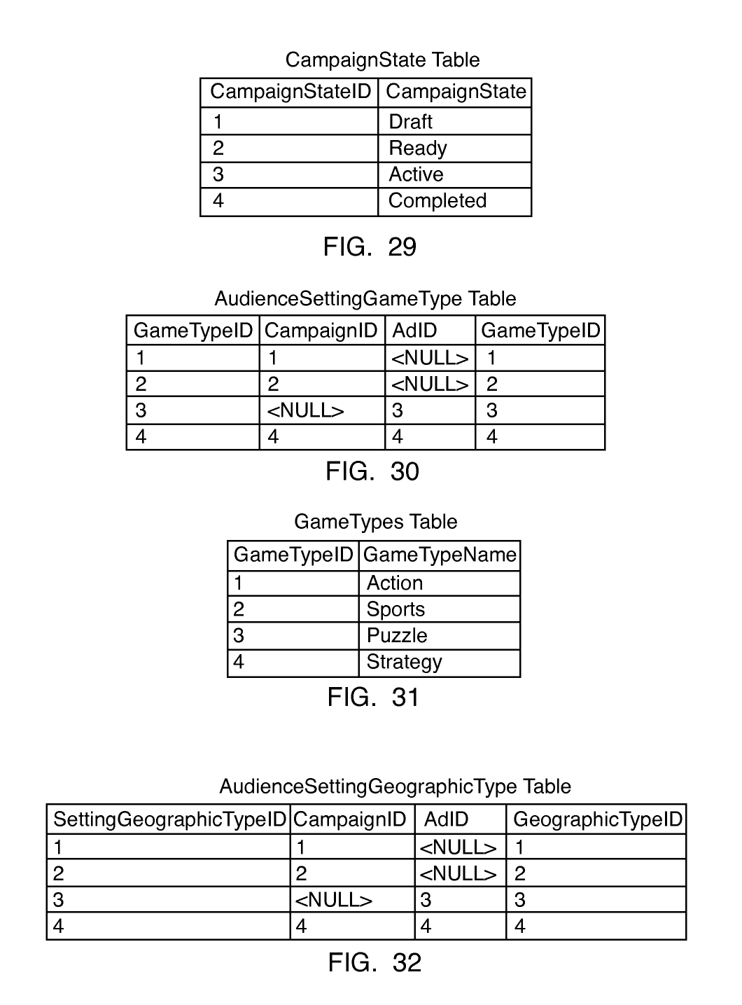

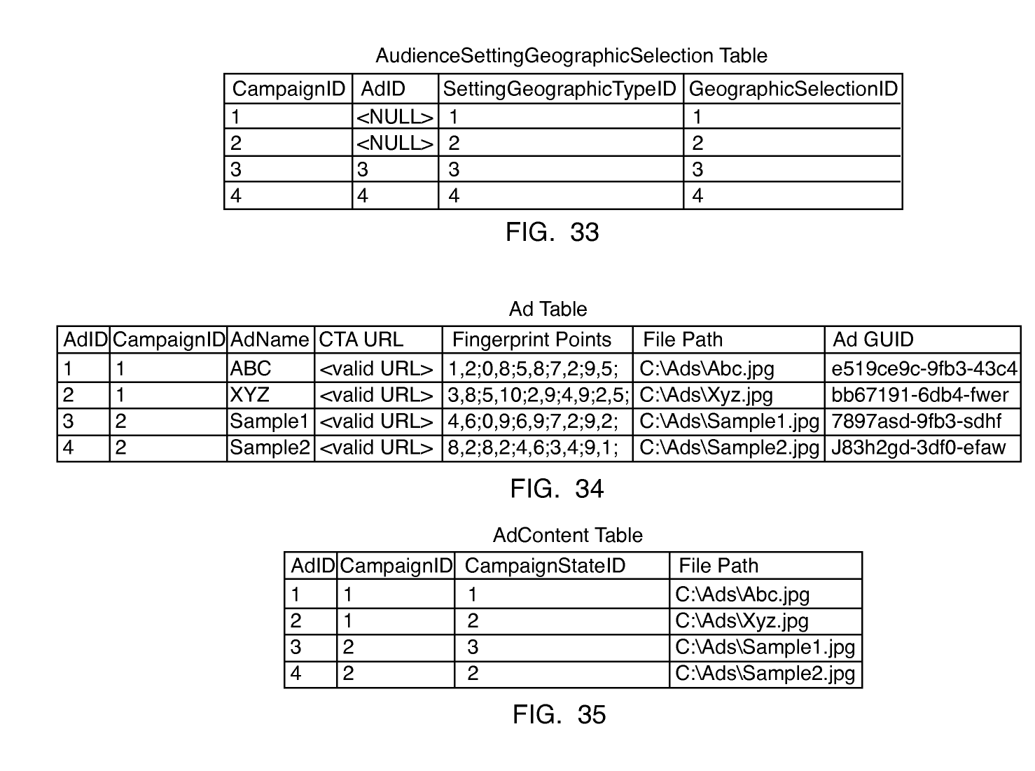

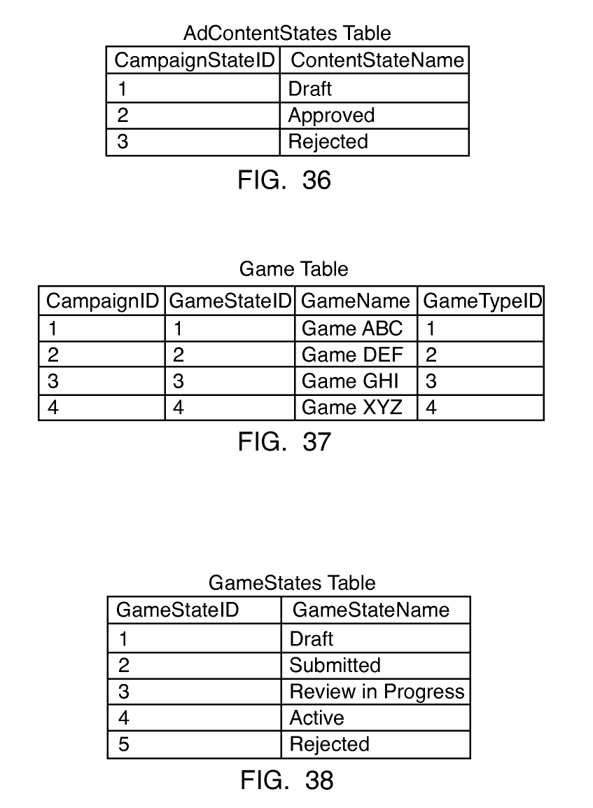

When the fingerprint on the client is triggered (the capture action) (see FIG. 19 step 3), each point is scaled to the current screen size and the red, green, and blue values are captured for the pixel at the given coordinates. These 3 points are then assembled into a new array that has the same number of elements as the original array that correspond to those points (see FIG. 19 step 4). This data is then added to the ad view packet which is stored in the broker's database and can be retrieved at a later time (see FIG. 19 step 5). The ad view data is sent back to the broker's webservice for ad tracking (see FIG. 19 step 6). FIG. 24 illustrates the detailed steps for generating fingerprint points. The broker's webservice calls the computer program Fingerprint processor component (see FIG. 19 step 7) to parse the data and save it to the system database (see FIG. 19 step 8). To validate the ad view, a separate program (the Audit Computer Program) is used to create a screen area that matches the original clients. The Audit Computer Program accepts an Ad View ID to connect to the system database and retrieve the information to audit (see FIG. 19 step 9). The Audit Computer Program renders the advertisement (see FIG. 19 step 10) and performs the same operation on the advertisement as was originally completed on the client (the capture action) (see FIG. 19 step 3 and 11). The Audit Computer Program determines if the points match those that were returned from the client (see FIG. 25 and FIG. 26). The Audit Computer Program doesn't use an exact match but uses a percentage to determine the closeness to the original color since small variances in display hardware will cause data to be different but appear the same to the human eye. If a certain number of array elements match the result, we can say that it is very certain that this ad was displayed on the screen. That amount is variable and controlled by the Audit Computer Program.

The broker's web site has many features that provide security at many levels using components of the computer program. Some of the features are: all page views are logged, all transactions are logged, data transferred is encrypted to and from the games, and audits are taken of suspicious actions such as invalid log in attempts and trying to access information the user cannot. Logging records the geographic information, user information (if available), the page where the action happened, a custom message for what happened, the date and time of the occurrence, and any data that may be relevant to the audit. An email is also sent to the broker system's administrator for notification.

### Database

There are many tables in the database, the core tables are “Campaign”, “Ad”, “Game Type Settings”, and “Geographic Settings” table (FIG. 27). The “Campaign” table (FIG. 28) acts as the logical grouping of advertisements. There is a one-to-many relationship with the “Ad” table (FIG. 24) via foreign key “CampaignID”. The Ad table stores the meta data of the advertisement and includes type of media (image or movie), parent campaign, display time of the ad, the call to action URL, and finger print points. The “Ad” table has a one-to-many relationship with the “AdContent” table (FIG. 35) which stores the information about this ads content approval. The “AdContent” table can have many entries since the advertiser can replace the advertising content after it has been created and for each new upload of ad content, a new entry in the “AdContent” table is made. The “AdContent” table content approval is done by broker system staff to ensure quality validation of the advertising content.

The settings for a campaign can be applied by the campaign as a whole (and all related ads) or on a per ad basis. The advertiser can choose the type of geography they are interested in reaching (country, region, state, and county) and then select which specific geographic setting they want (for example: select the type of state and the specific setting of Connecticut). This is supported by having two tables that are linked to the “Campaign” and/or the table named “AudienceSettingGeograhicTypes” and “AudienceSettingGeograhicSelection”. The “AudienceSettingGameTypes” table is also used in a similar manner to set the game types the campaign or ad wants to reach.

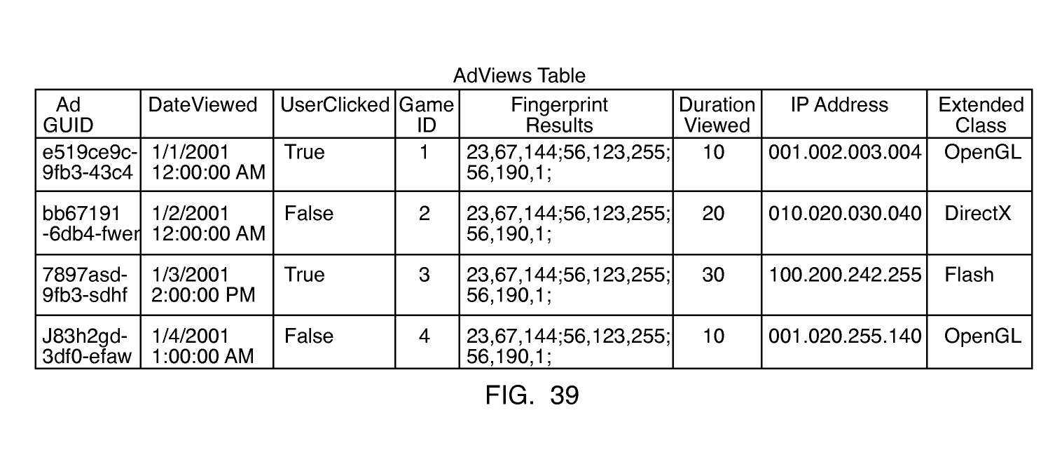

The “AdView” table (FIG. 39) is used to store the result of a successful AdView by the gamer. An entry is made each time a gamer completes viewing an ad. This table provides the lowest level of detail about how many ads were served and contains data that helps to understand the geography of the view, if the call to action was taken, the fingerprint results, how long the ad was actually viewed, the extended class used (DirectX, OpenGL, Flash), the screen resolution this ad was viewed at, the operating system, and the meta data the game company wants to pass back. The MetaData field is used as a blank storage area where the game company can include any additional information they might be interested in capturing. For example, the game company might want to know what level of the game the ad was shown at so they could put the level number in the metadata field. The company that provides the broker service would then work with the game company to create a custom report to help display the meta data captured.

The “Game” table (FIG. 37) stores the individual games that have broker service activated. The state field helps track the progress of the game through the lifecycle. The game is created by the game company and after the save to the database the generated GameGuid is returned to the game company. The game company then takes the GameGuid and sets the GameGuid property in the broker-service-enabling SDK to the GameGuid created. The game company now test the game with the Guid and test ads will be served to demonstrate the service is working and validate how and when the ads will be shown in the game. The game type information about each game is reviewed by the staff who administrate the broker service before the game is activated and starts serving live ads. This ensures that there is control and quality validation in the game content.

We claim:

1. A method of using computer and internet to allow advertisers to purchase advertisement space in video games and to enable advertisers to reach targeted video-game players who play computer-based video-games, comprising the steps of:
registering, using a computer and internet connection, an advertisement campaign from
an advertiser, said advertisement campaign containing advertisement information,
advertisement contents, and audience settings;
registering, using a computer and internet connection, a game entry from a game
company, said game entry containing basic game information;
releasing a GUID and an broker-service-enabling SDK to the said game company, the said GUID is a unique identifier used to track the game through the
process, the said broker-service-enabling SDK containing all needed library files and help files;
integrating the said broker-service-enabling SDK into the game corresponding to the said game entry,
by copying the library and header files, setting up the development environment,
copying the code from help documents to the game source file, and replacing areas
that ask for the game GUID with the said GUID;
testing the said game, by verifying the advertisements display as expected, and by
confirming the test result by viewing the test reports; if the test results are satisfactory,
submitting the said game, by uploading the said game in its final release format,
reviewing and approving by staff who administrate the broker service, by verifying the content of the said game,
the quality of the said game; if the said game is approved,
releasing the said game as a part of the live network;
distributing the said game in the way the game company chooses;
displaying the said advertisement in the way defined in the said advertisement
campaign to the video game players who play the said game, if the said game players
match the said audience settings.
